(19) United States
(12) Patent Application Publication
(10) Pub. No.: US 2010/0162128 A1
(43) Pub. Date: Jun. 24, 2010

(54) User interfaces and associated apparatus and methods

(76) Inventors: Nigel Richardson, Surrey (GB); Natalie Vanns, Kent (GB); Brian Davidson, Surrey (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/339,351

(22) Filed: Dec. 19, 2008

(51) Int. Cl. G06F 3/00

(52) U.S. Cl. 715/744; 345/173

(57) ABSTRACT

A controller includes one or more inputs configured to receive data representative of whether a device is in a first or second operating mode. The device comprising first and second user interfaces. The controller is configured to: in the first operating mode, provide output to cause information to be displayed on the first user interface and cause information not to be displayed on the second user interface; and in the second operating mode, provide output to cause information to be displayed on both of the first and second user interfaces.

### TECHNICAL FIELD

The present disclosure relates to the field of controllers, in particular controllers for providing output to cause information to be displayed on one or both of first and second user interfaces of a device, associated methods, computer program products and apparatus.

Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Mobile devices with large user interface (UI) area are desirable for web browsing, navigation, etc. However, there is a desire to keep the overall size of the device as small as possible for portability and/or carrying in a pocket, handbag, etc.

Devices with a single large display are known, such as the Apple iPhone. Devices with two large displays which can be presented to a user are also known, such as the Nintendo DS.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided a controller comprising:
one or more inputs configured to receive data representative of whether a device is in a first or second operating mode, the device comprising first and second user interfaces; and wherein the controller is configured to:
in the first operating mode, provide output to cause information to be displayed on the first user interface and cause information not to be displayed on the second user interface; and
in the second operating mode, provide output to cause information to be displayed on both of the first and second user interfaces.

In this way, a controller can be provided that makes efficient use of the two user interfaces in accordance with an operating mode of the device. For example, the controller may enable one or more application programs to be efficiently, effectively and conveniently viewed by a user of the device associated with the controller, and may make efficient use of power/electricity. This may be particularly useful for battery operated devices.

The first and/or second user interfaces may comprise a touch screen display, a user output interface, a display screen, physical buttons or any combination thereof.

Only the first user interface may be configured for receiving user input, as it is the first user interface that is in use in both of the first and second operating modes. This can ensure that a user can provide input in both modes of operation. This can also reduce the cost of the device as the second user interface does not need components to allow it to receive user input. The first user interface may be a touch sensitive screen, and the second user interface may be a display screen.

In other embodiments, both user interfaces may be configured for receiving user input.

In use in the second operating mode, the first user interface may be nearer to a user than the second user interface.

The information that is displayed on the first user interface when the device is in the first operating mode may be a portion of a web page, and the information that is displayed on both of the first and second user interfaces when the device is in the second operating mode may comprise the same web page split over the two user interfaces. This can enable a device to be switched from the first operating mode to the second operating mode to display more of a web page.

When the device is in the second operating mode, the first user interface may be configured for receiving user input; and the second user interface may be configured for displaying information related to user input received at the first user interface.

In one example, the first user interface may be a touch screen; and the controller causes the first user interface to display a keyboard with which a user can interact; and the controller causes the second user interface to display a response to user interaction with the first user interface.

In another example, the first user interface may be a touch screen; and the controller causes the first user interface to display gaming controls with which a user can interact; and the controller causes the second user interface to display a game that is controlled by signals representative of user interaction with the controls displayed on the first user interface.

The controller may comprise a module for a device.

There may be provided a device/apparatus comprising:
a controller comprising:
   one or more inputs configured to receive data representative of whether a device is in a first or second operating mode, the device comprising first and second user interfaces; and wherein the controller is configured to:
   in the first operating mode, provide output to cause information to be displayed on the first user interface and cause information not to be displayed on the second user interface; and
   in the second operating mode, provide output to cause information to be displayed on both of the first and second user interfaces.

The device/apparatus comprising the controller may further comprise:a first part comprising the first user interface; and
a second part comprising the second user interface;
wherein the device/apparatus is configured such that the first part and second part are movable relative to each other to define first and second configurations, and wherein the device/apparatus is configured to switch between first and second operating modes according to whether the device/apparatus is in the first or second configuration.

In this way, a user can manipulate the first and second parts to place the device/apparatus in one of a first and second configuration, and the controller can control the display of information on user interfaces associated with the first and second parts in accordance with the configuration of the device/apparatus.

The first and second parts may be slidable relative to each other in order to define the first and second configurations. The first and second parts may be slidable relative to each other in the same plane, or substantially the same plane.

The apparatus/device may further comprise a housing, and the first part and second part may be movable relative to the housing in order to define the first and second configurations.

The first user interface may be visible to a user and the second user interface may not be visible to a user when the apparatus is in the first configuration. Both of the first and second user interfaces may be visible to a user when the apparatus is in the second configuration. The first configuration may be a closed configuration and the second configuration may be an open configuration.

The first part may obscure the second user interface when the apparatus is in the first configuration.

According to a second aspect, there is provided a method for displaying information on first and second user interfaces of a device, the method comprising:
receiving data representative of whether the device is in a first or second operating mode; and
in the first operating mode, providing output to cause information to be displayed on the first user interface and cause information not to be displayed on the second user interface; and
in the second operating mode, providing output to cause information to be displayed on both of the first and second user interfaces.

The method may further comprise, in the second operating mode:
providing output to cause information to be displayed on the first user interface that provides options to a user of what information should be displayed on the two user interfaces;
receiving user input in response to the information displayed on the first user interface; and
responsive to user input; performing one of the following further method steps:
(i) displaying information associated with a first application on the first user interface, and displaying information associated with a second, different, application on the second user interface. For example, an e-mail application such as Microsoft Outlook may be displayed on one user interface and a picture editing application for displaying picture attachments with the e-mail, such as Adobe Photoshop may be displayed on the other user interface.
(ii) displaying information associated with a first application on the first user interface, and displaying information associated with the same first application on the second user interface. For example, different websites may be displayed on the two user interfaces, using Microsoft Internet Explorer as the application program.
(iii) displaying information associated with an instance of a first application on a first user interface, and displaying information associated with the same instance of the same first application on the second user interface. For example, displaying one website split over the two user interfaces using Microsoft Internet Explorer as the application program.

According to a further aspect of the invention, there is provided a computer program, which may be recorded on a carrier, the computer program comprising computer code configured to perform a method for displaying information on first and second user interfaces of a device, the method comprising:
receiving data representative of whether the device is in a first or second operating mode; and
in the first operating mode, providing output to cause information to be displayed on the first user interface and cause information not to be displayed on the second user interface; and
in the second operating mode, providing output to cause information to be displayed on both of the first and second user interfaces.

The computer program may be operable to configure a controller, apparatus or device disclosed herein.

There may be provided a computer-readable storage medium having stored thereon a data structure comprising the computer program for execution by a processor in carrying out the method.

There may be provided a method of assembling an apparatus/device comprising:
a controller comprising:
   one or more inputs configured to receive data representative of whether a device is in a first or second operating mode, the device comprising first and second user interfaces; and wherein the controller is configured to:
   in the first operating mode, provide output to cause information to be displayed on the first user interface and cause information not to be displayed on the second user interface; and
   in the second operating mode, provide output to cause information to be displayed on both of the first and second user interfaces.

The device/apparatus comprising the controller may further comprise:
a first part comprising the first user interface; and
a second part comprising the second user interface;
wherein the device/apparatus is configured such that the first part and second part are movable relative to each other to define first and second configurations, and wherein the device/apparatus is configured to switch between first and second operating modes according to whether the device/apparatus is in the first or second configuration.

According to a further aspect of the invention, there is provided an apparatus, the apparatus comprising,
one or more input means configured to receive data representative of whether a device is in a first or second operating mode, the device comprising first and second user interface means; and wherein the apparatus is configured to:
in the first operating mode, provide output to cause information to be displayed on the first user interface means and cause information not to be displayed on the second user interface means; and
in the second operating mode, provide output to cause information to be displayed on both of the first and second user interface means.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE DRAWINGS

A description is now given, by way of example only, with reference to the accompanying drawings, in which;

FIGS. 1a, 1b and 1c illustrate an apparatus according to an embodiment of the invention;

FIGS. 2a and 2b illustrate a comparison between a prior art apparatus and an apparatus according to an embodiment of the invention;

FIG. 3 illustrates schematically an apparatus according to a further embodiment of the invention;

FIGS. 4a and 4b illustrate two user interfaces according to an embodiment of the invention displaying a web page;

FIG. 5 illustrates two user interfaces according to an embodiment of the invention displaying an instant messaging application;

FIG. 6 illustrates two user interfaces according to an embodiment of the invention displaying a gaming application; and

FIG. 7 illustrates schematically method steps according to an embodiment of the invention.

### DETAILED DESCRIPTION OF SPECIFIC ASPECTS/EMBODIMENTS

One or more embodiments described herein relate to a device having two user interfaces that can display information to a user of the device. The device can have at least two physical configurations with associated operating modes, for example open and closed configurations, and embodiments described herein describe apparatus and methods that are used to control how, and when each of the two user interfaces are used.

For example, in an embodiment of the device wherein a first user interface obscures a second user interface when the device is closed, apparatus and/or methods described herein can ensure that information is only displayed on the first user interface, and not on the second user interface. However, when the device is open, and both of the first and second user interfaces are visible to a user, apparatus and/or methods described herein may cause information to be displayed on both of the first and second user interfaces. The displayed information may be complementary/related. Controlling the display of information in this way can make efficient use of power and provide a user with the most convenient display of information in accordance with the configuration and associated mode of operation of the device.

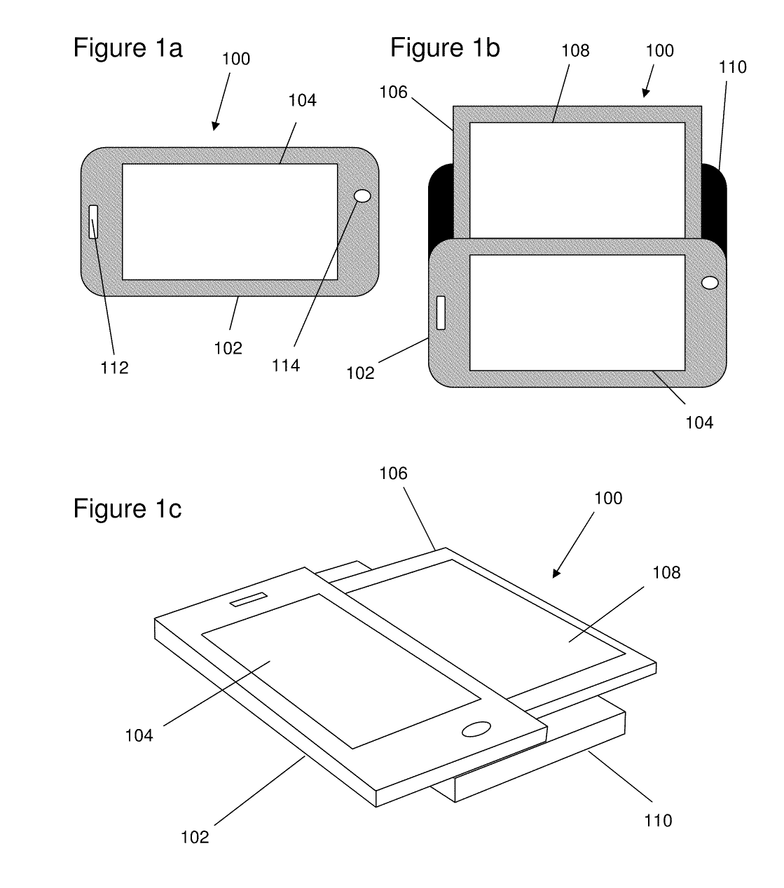

FIGS. 1a, 1b and 1c illustrate three different views of a device 100 according to an embodiment of the invention. In this embodiment, the device 100 is a mobile telephone. FIG. 1a shows a plan view of the device 100 in a closed configuration, FIG. 1b shows a plan view of the device 100 in an open configuration, and FIG. 1c shows a perspective view of the device 100 in the open configuration.

When the device is in the closed configuration as in FIG. 1a, a first user interface 104 is visible to a user. The first user interface 104 is located on a first part 102 of the device. The first part 102 is positioned above a second part (not shown in FIG. 1a, but shown as reference 106 in FIG. 1b), which is positioned above a housing (not shown in FIG. 1a, but shown as reference 110 in FIG. 1b). The first part substantially covers the second part 106, which substantially covers the housing 110. When the device 100 is in the closed configuration, it has a monoblock form-factor, and can be used for making and receiving calls using the microphone 114 and speaker 112. The device 100 may also have physical push buttons (not shown in this embodiment) on the first part 102 for operating the device.

FIGS. 1b and 1c show the device 100 in an open configuration. In order to transition from the first configuration to the second configuration, the first and second parts 102, 106 are laterally slid apart relative to each other, and at the same time, the two parts 102, 106 are laterally slid away from a housing 110.

When the device 100 is in the open configuration, the first user interface 104 on the first part 102 is visible to a user, and a second user interface 108 on a second part 106 of the device 100 is also visible to the user. The second user interface 108 has been exposed/uncovered from beneath the first part 102.

As can be seen more clearly in FIG. 1c, the first part 102 and the second part 106 of the device 100 are slid apart relative to a housing 110 in order to expose the second user interface 108 from underneath the first part 102.

It will be appreciated that the user interfaces 104, 108 described herein may include a display screen, a touch sensitive display screen, one or more buttons that can be pressed by a user, and any combination thereof.

As will be described in more detail, an apparatus and/or controller is provided for controlling the information that is displayed on the first and second user interfaces 104, 108.

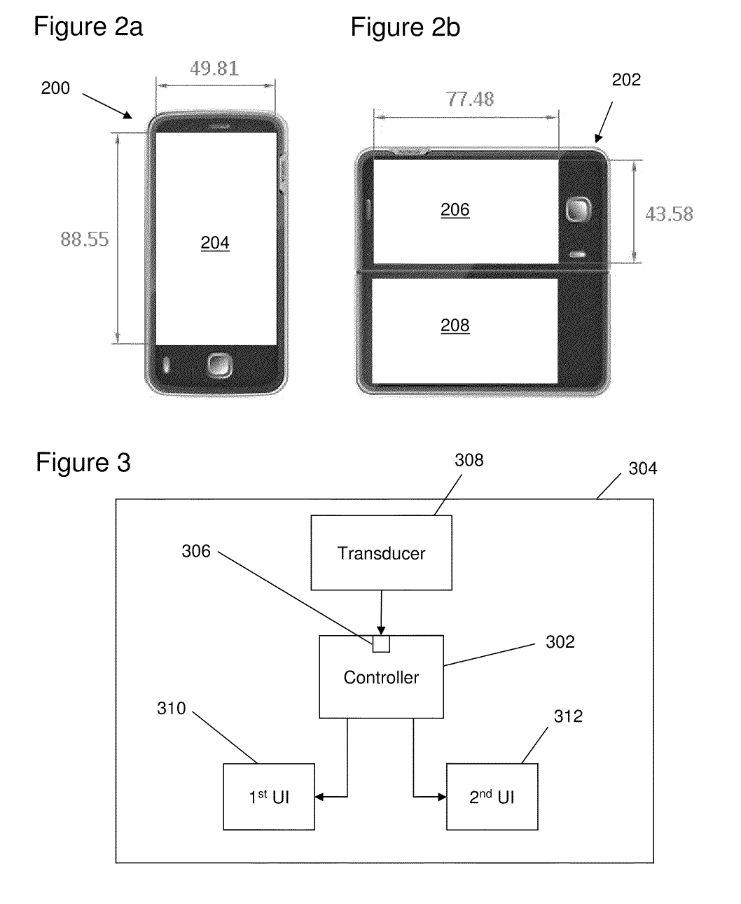

FIGS. 2a and 2b illustrate a comparison between a maximum screen area of a device 202 according to an embodiment of the invention, with the screen area of a single display device 200.

A known single display device 200 is shown as FIG. 2a, and has a known 4.0 inch screen having dimensions of 49.81 mm×88.55 mm, thereby providing a screen area of 44.1 cm².

In contrast, a device 202 according to an embodiment of the invention in an open configuration is illustrated in FIG. 2b. When the device 202 is in the open configuration, two 3.5 inch screens are visible to a user. Each screen has dimensions of 43.58 mm×77.48 mm, thereby providing a total screen area of 67.4 cm². The device 202 of FIG. 2b provides a 65.43% increase in maximum screen area compared with the prior art device 200 illustrated in FIG. 2a, even though the size of the device 202 when in the closed configuration is comparable to the size of the prior art device 200.

FIG. 3 illustrates a controller 302 that can provide output to cause information to be displayed on one or more of a first and second user interface 310, 312.

In this embodiment, the controller 302 is part of an apparatus 304 including the first user interface 310, the second user interface 312, and a transducer 308. However, it will be appreciated that the controller 302 could be provided in isolation as a module that can be inserted into an apparatus/device to configure the apparatus/device according to an embodiment of the invention.

The controller 302 has one or more inputs 306 configured to receive a signal from a transducer 308. The transducer 308 provides a signal representative of the configuration of a device associated with the apparatus 304. For example, the apparatus 304 may be associated with the device 100 illustrated in FIG. 1, and the output signal of the transducer 308 provides an indication of whether the device 100 is in an open or closed configuration. A first operating mode may be associated with the device being in a first configuration, and a second operating mode may be associated with the device being in a second configuration.

The transducer 308 may detect the configuration of the device, and in some embodiments the configuration of the first part 102 relative to the second part 106 of the device 100 illustrated in FIG. 1, by any known means. For example, microswitches may be used to detect the relative position of the two parts 102, 106, magnets may be associated with the two parts 102, 106 in order that voltages generated by the Hall effect can be monitored, or infrared transmitters and receivers could be used to determine the configuration of the device.

The output signal of the transducer 308 representative of the configuration of the device is provided to the input 306 of the controller 302.

The controller 302 is configured to process the signal received at its input 306 and determine whether the device is in a first configuration or a second configuration. If the device is in the first configuration, then the controller 302 provides an output signal to the first user interface 310 to cause information to be displayed on the first user interface 310. When the device is in the first configuration, the controller 302 does not send information to the second user interface 312 such that no information is displayed on the second user interface 312. This may be because the second user interface 312 is not visible to a user when the device is in the first configuration, and displaying information on the second user interface 312 may waste power and cause displayed information to be missed by a user.

If the controller 302 determines that the device is in a second configuration, then the controller 302 provides an output signal to both the first user interface 310 and the second user interface 312 to cause information to be displayed on both of the first and second user interfaces 310, 312. This may be because both of the first and second user interfaces 310, 312 are visible to a user when the device is in the second configuration.

Examples of information that can be displayed on the user interfaces 310, 312 will be described in more detail below.

Advantages associated with embodiments described herein can include an efficient use of power because only those user interfaces 310, 312 that are visible to a user are used to display information. This can be particularly important for battery powered devices. The ability for a user to increase the maximum display area by changing the device from a first configuration to a second configuration in accordance with the requirements of what is being viewed/displayed can also mean that only the minimum amount of power that is required to display the desired information can be used.

Further advantages can include that at least one user interface is always visible to a user, and therefore the user can view information on a user interface, and in some embodiments provide input through the user interface, independent of the configuration of the device, and can provide the user with flexibility to expose and obscure different user interfaces depending upon their needs. For example, if they want to view more than one set of information at the same time, but doing so on a single user interface would not be possible/would not provide sufficient resolution, then they can change the configuration of the device so that two user interfaces are visible. The second user interface could also be exposed by opening the device when a user wants to run a different application to that being displayed on the first user interface.

In some embodiment, when a device is transitioned from a first configuration to a second configuration, the controller may cause a number of options to be displayed to the user providing alternative ways to display information on the two user interfaces. The options may be displayed on the second user interface, that is, the user interface that has been uncovered. Options for displaying information may include displaying a different application on the second user interface, displaying a different instance of the same application program on the second user interface and displaying the same instance of the same application program on the second user interface. These are discussed in more detail later.

Some embodiments described herein can be used for single task handling, that is one or both of the user interfaces can be used for handling a single task, such as a single application program. Other embodiments described herein can be used for multi-task handling, for example where different user interfaces are used for handling different application programs.

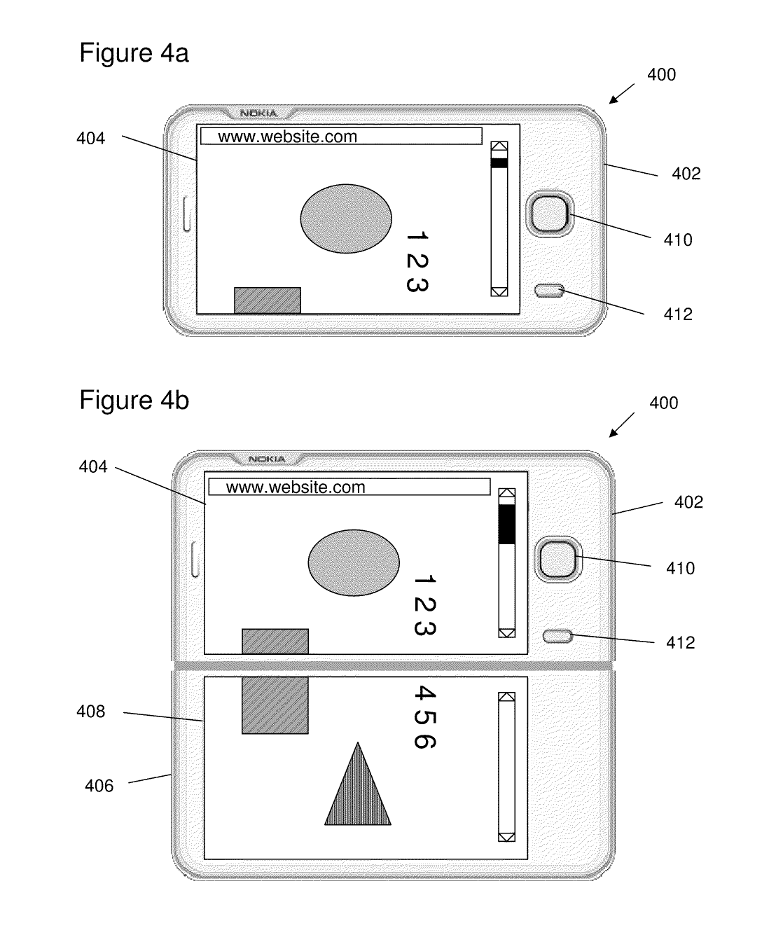

FIGS. 4a and 4b illustrate a device 400 according to an embodiment of the invention that is being used for web browsing.

FIG. 4a illustrates the device 400 in a first/closed configuration wherein a first part 402 of the device 400 covers a second part of the device (406 as illustrated in FIG. 4b). In this embodiment, the first part 402 comprises a user interface that includes a touch-screen display 404, a physical directional button 410 and a select button 412. It will be appreciated that the user interface in different embodiments of the invention can comprise one or more of the touch screen display 404 and buttons 410, 412.

When the device 400 is in the first configuration as illustrated in FIG. 4a, a web page is displayed on the touch screen 404, for example using Microsoft Internet Explorer web browser as an application program.

When the device is in a second configuration as illustrated in FIG. 4b, a second display screen 408 of the second part 406 of the device 400 is exposed. As the device is transitioned from the first configuration in FIG. 4a to the second configuration illustrated in FIG. 4b, a transducer (not shown) associated with the device 400 provides a controller of the device with a signal representative of the configuration change. As illustrated in FIG. 3, the controller provides signals to the first and second user interfaces to control how information is displayed on both screens 404, 408.

In this embodiment, the controller is configured to provide signals to the first and second screens 404, 408 such that they display information associated with the same instance of the same application program. That is, a single web page is displayed by a single application program (such as Microsoft Internet Explorer) across the two screens 404, 408. The information may be displayed in this way as a default position in accordance with the application program (Microsoft Internet Explorer) that is running, or may be preset by a user, or may be selected by a user when the configuration of the device 400 is transitioned from the first configuration to the second configuration.

It will be appreciated that by displaying information associated with the same instance of the same application program can enable more information to be displayed to a user of the device 400. This can make web pages more readable, and can enable a user to be able to view more content at any one time by dividing or splitting the content into separate parts for adjacent placement and display on the correspondingly adjacent first and second screens 404, 408.

In alternative embodiments, multiple web windows can be split between the two displays 404, 408 and this may involve different instances of the same application program (Microsoft Internet Explorer) being displayed on the first and second user interfaces. For example, a first web page may be displayed on the first user interface 404 and a second, different web page may be displayed on the second user interface.

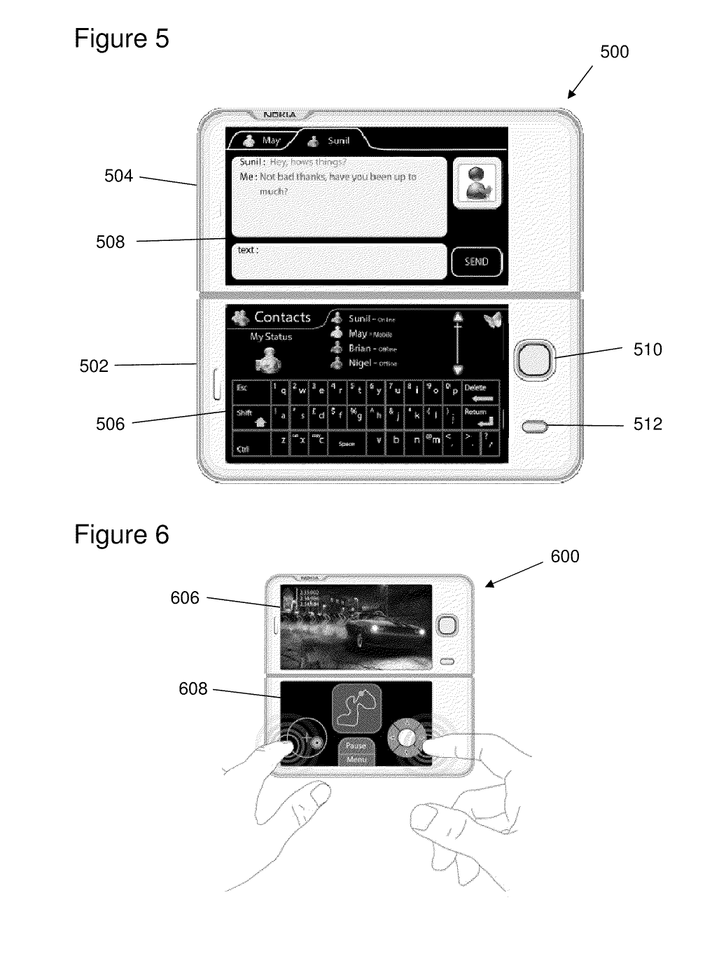

FIG. 5 illustrates a device 500 in an second/open configuration according to an embodiment of the invention. The device 500 comprises a first part 502 having a touch sensitive screen 506, and two push buttons 510, 512. In some embodiments, the touch screen may comprise a user interface, and in other embodiments the touch screen 504 along with the two push buttons 510, 512 may together comprise the user interface. The device 500 also includes a second part 504 having a second user interface/display screen 508.

In this embodiment, the first touch sensitive display 506 displays a qwerty keyboard and address book such that the user can enter information into an instant messaging application, such as MSN messenger, and the ongoing conversation can be displayed on the second display screen 508. In this embodiment, it will be appreciated that the second display screen 508 does not necessarily need to be a touch sensitive display screen as it is only used to display information, and not used to receive user input.

In some embodiments, the device 500 may be configured such that the first user interface 506 is nearest a user when the device 500 is being used in the second configuration. This can make efficient use of the two user interfaces, as it may only be necessary to have one user interface that is configured to receive user input. It may be beneficial that the user interface that is configured to receive user input is also available when the device is in the first/closed configuration, and the same user interface is also nearest the user when the device 500 is in the second/open configuration.

FIG. 6 illustrates a further embodiment of a device 600 in a second/open configuration of operation. The device 600 comprises the same components as the device described and illustrated in relation to FIGS. 4 and 5, and in this embodiment the device 600 is used to play a game.

In this embodiment, the first user interface display screen 606 is used to display the main game screen, for example a car on a track for a racing game, and the second user interface touch sensitive display screen 608 is used to display controls with which a user can interact to play the game. In addition, the second touch sensitive display screen 608 can also display shortcuts, control options, and be used to set up the sensitivity and define controls as desired by a user.

Further examples of how a device according to an embodiment of the invention can be used for single task handling include:

Web Browsing: Internet pages can be viewed over two screens, making them far more readable, and the user is able to view much more content at any one time. Alternatively multiple web windows could be split between the two displays.

Messaging: Multi window instant messaging applications would suit a dual screen interface, enhancing the user experience of services like Skype, MSN, Yahoo messenger and GMail. One screen could be used to provide the qwerty keyboard and address book, the other the text window(s).

Music: Dual screen allows many advantages for media functions such as browsing a music library. One screen can display the track that is playing, while the other can be used to browse through the music library, or play lists.

Imaging: Manipulation on a dual screen device can be easier, being able to browse through thumbnails on one screen, the other can be used to view, or edit them.

Image Capture: Main viewfinder view on one display, a full range of image taking options for example flash, light level, focusing information on the other.

Movie Viewing: The main film screen is handled on one display, the other the movie library, timer/counter, scene selection etc.

Gaming: The main game scene view can be displayed on one screen, the controls on the other. The user could customise the game controls, define shortcuts, set up the sensitivity and define control as they wished.

The common theme in the six use cases listed above is the splitting of one activity or application between two displays—main function on one screen, other subsidiary functions on the other. Other applications could benefit from a dual user interface such as e-books and newspapers where the increased display area is used to present more information to the user instead of splitting between main and subsidiary functions.

In order to handle multiple applications, that is multitask handling operations, the user interface may be capable of presenting the user with the following functionality:
Opening multiple applications.
Navigation through multiple applications.
Copying information from one application to another.

Some examples of multi-task handling using a dual display interface are now described:

A dual screen interface can accommodate the needs of media multitasking by allowing the simultaneous use of web browsing, email, music track selection in conjunction with instant messaging and social networking sites. Primary user tasks and actions can include: opening multiple applications, navigating through multiple applications, copying information from one application to another.

Web browsing in conjunction with location based services. One display is used for navigation using GPS, the other is used to display web searches of particular locations the user may wish to visit or be informed about.

Web browsing and secure purchasing. One display is used to display a web site from which the user wishes to make a purchase, the other displays the secure purchasing site such as Paypal so the user is able to initiate the transaction.

Composing a text while watching a movie. One display presents the user with a full qwerty keyboard, while the other display presents the movie to the user.

The two separate screens can give an opportunity to use the second screen to display favorite information, such as weather, stocks and shares, sports scores etc. It could also monitor an email inbox to display when new messages have been received.

When both displays are in use and the user wishes to make the device more compact by closing it, the user interface software can, in certain circumstances/applications, permit the user to continue their task on the one remaining visible screen without interruption. In other instances it may be desirable to have the user interface close one application and open another.

Similarly when a device is opened and a second display presented to the user, the user interface software may be configured to use the second display to open a new application or to split the existing application between the two displays.

The addition of touch interface functionality to one or both of the displays showing the dual display interface may provide opportunities for new user interaction; for example touching and dragging an item from one display and then tapping the second display to place it there.

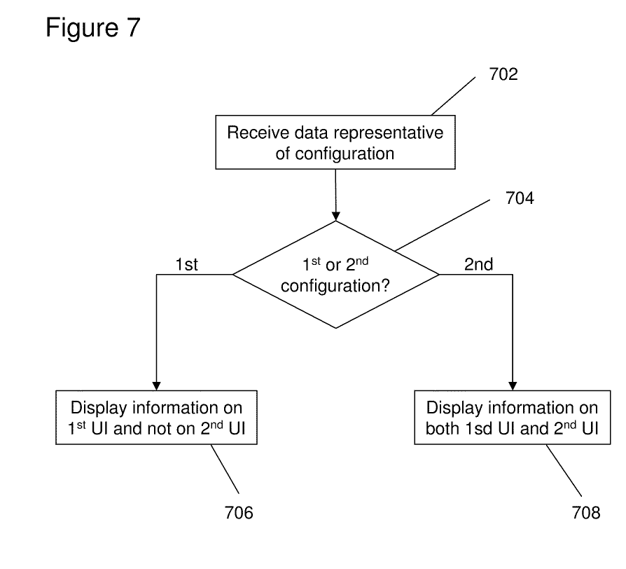

FIG. 7 illustrates schematically a method that can be performed for displaying information on one or both of two user interfaces according to an embodiment of the invention.

At step 702, data representative of whether a device is in a first or second configuration is received. This data can be received from a transducer that is associated with one or more moving parts of the device to determine their physical relation with each other, thereby defining different configurations of use.

At step 704, a determination is made based on the received data as to whether the device is in a first or second configuration. If the device is in a first configuration, it is considered to be in a first operating mode, and if the device is in a second configuration it is considered to be in a second operating mode. That is, the device can have different operating modes depending upon its physical configuration.

If the device is in the first operating mode, then the method moves on to step 706 whereby information is displayed on the first user interface, and not on the second user interface. If the device comprises more than two user interfaces, information may or may not be displayed on the third, or any subsequent, user interfaces. Step 706 may be configured to make efficient use of power by ensuring that power is not wasted by displaying information on a user interface that is not visible to a user when the device is in the first operating mode.

If it is determined that the device is in the second operating mode at step 704, the method moves on to step 708 whereby information is displayed on both of the first and second user interfaces. Step 708 can enable more information to be displayed to a user, without necessarily compromising the quality and/or resolution of the information. A user may place the device in a second mode of operation when they determine that the first user interface is not large enough to display the information that they wish to view, or if they want to open further application programs whilst simultaneously viewing the information that is already being displayed.

It will be appreciated by any person of skill in the art that the apparatus/device/server and/or other features of particular apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor and/or on one or more memories/processors.

It will be appreciated that the aforementioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

With reference to any discussion of processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of any person skilled in the art, irrespective of whether such features or combinations of features solve any problems disclosed herein, and without limitation to the scope of the claims. The applicant indicates that the disclosed aspects/embodiments may include any such individual feature or combination of features. In view of the foregoing description it will be evident to any person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A controller comprising:
one or more inputs configured to receive data representative of whether a device is in a first or second operating mode, the device comprising first and second user interfaces; and wherein the controller is configured to:
in the first operating mode, provide output to cause information to be displayed on the first user interface and cause information not to be displayed on the second user interface; and
in the second operating mode, provide output to cause information to be displayed on both of the first and second user interfaces.

2. The controller of claim 1, wherein the first user interface comprises a touch screen display.

3. The controller of claim 1, wherein the second user element comprises a touch screen display.

4. The controller of claim 1, wherein the information that is displayed on the first user interface when the device is in the first operating mode is a portion of a web page, and the information that is displayed on both of the first and second user interfaces when the device is in the second operating mode comprises the same web page split over the two user interfaces.

5. The controller of claim 1, wherein, when the device is in the second operating mode:
the first user interface is configured for receiving user input; and
the second user interface is configured for displaying information related to user input received at the first user interface.

6. The controller of claim 1, wherein:
the first user interface is a touch screen; and
the controller causes the first user interface to display a keyboard with which a user can interact; and
the controller causes the second user interface to display a response to user interaction with the first user interface.

7. The controller of claim 1, wherein:
the first user interface is a touch screen; and
the controller causes the first user interface to display gaming controls with which a user can interact; and
the controller causes the second user interface to display a game that is controlled by signals representative of user interaction with the controls displayed on the first user interface.

8. The controller of claim 1, comprising a module for a device.

9. Apparatus comprising the controller of claim 1, and:
a first part comprising the first user interface; and
a second part comprising the second user interface;
wherein the apparatus is configured such that the first part and second part are movable relative to each other to define first and second configurations, and wherein the apparatus is configured to switch between first and second operating modes according to whether the device is in the first or second configuration.

10. The apparatus of claim 9, wherein the first and second parts are slidable relative to each other in order to define the first and second configurations.

11. The apparatus of claim 10, wherein the first and second parts are slidable relative to each other in the same plane.

12. The apparatus of claim 9, further comprising a housing, and wherein the first part and second part are movable relative to the housing in order to define the first and second configurations.

13. The apparatus of claim 9, wherein the first user interface is visible to a user and the second user interface element is not visible to a user when the apparatus is in the first configuration.

14. The apparatus of claim 13, wherein the first part obscures the second user interface when the apparatus is in the first configuration.

15. A method for displaying information on first and second user interfaces of a device, the method comprising:
receiving data representative of whether the device is in a first or second operating mode; and
in the first operating mode, providing output to cause information to be displayed on the first user interface and cause information not to be displayed on the second user interface; and
in the second operating mode, providing output to cause information to be displayed on both of the first and second user interfaces.

16. The method of claim 15, further comprising, in the second operating mode:
providing output to cause information to be displayed on the first user interface that provides options to a user of what information should be displayed on the two user interfaces;
receiving user input in response to the information displayed on the first user interface; and
responsive to user input; performing one of the following further method steps:
(i) displaying information associated with a first application on the first user interface, and displaying information associated with a second, different, application on the second user interface;
(ii) displaying information associated with a first application on the first user interface, and displaying information associated with the same first application on the second user interface; and
(iii) displaying information associated with an instance of a first application on a first user interface, and displaying information associated with the same instance of the same first application on the second user interface.

17. A computer program, recorded on a carrier, the computer program comprising computer code configured to perform the method of claim 15.

18. A computer-readable storage medium having stored thereon a data structure comprising the computer program of claim 17.

19. A method of assembling an apparatus according to claim 9.

20. Apparatus comprising,
one or more input means configured to receive data representative of whether a device is in a first or second operating mode, the device comprising first and second user interface means; and wherein the apparatus is configured to:
in the first operating mode, provide output to cause information to be displayed on the first user interface means and cause information not to be displayed on the second user interface means; and
in the second operating mode, provide output to cause information to be displayed on both of the first and second user interface means.
